(19) United States
(12) Patent Application Publication
(10) Pub. No.: US 2009/0121365 A1
(43) Pub. Date: May 14, 2009

(54) Eddy chamber

(76) Inventors: Frank Jacobs, Klagenfurt (AT); Hans-Jurgen Diehl, Klagenfurt (AT)

Correspondence Address: FRIEDRICH KUEFFNER, 317 MADISON AVENUE, SUITE 910, NEW YORK, NY, 10017, US

(21) Appl. No.: 11/990,800

(22) PCT Filed: Aug. 23, 2006
(86) PCT No.: PCT/AT2006/000348

§ 371 Date: Apr. 18, 2008

(30) Foreign Application Priority Data
Aug. 24, 2005 (AT) A13952005

(51) Int. Cl. B01F 3/04; B01F 13/00

(52) U.S. Cl. 261/76; 366/341

(57) ABSTRACT

The invention relates to an eddy chamber for generating turbulence in a medium flowing through the chamber, comprising an inlet opening, an outlet opening and at least two constrictions in the cross-section thereof. In the region of the constrictions, the inner profile of the eddy chamber has the form of wave crests (10, 12, 25, 27, 30) in section parallel to the longitudinal axis thereof. According to the invention, the mixing may be improved and the pressure drop held small, whereby the angle to the longitudinal axis (z) in the direction of the outlet opening (15, 31) at the inflection points (12a, 25a, 27a, 30a) on the flanks of at least two wave crests (10, 12, 25, 27, 30) facing the inlet opening (9, 23) is larger. The invention further relates to a device for the enrichment of a liquid medium with a gaseous medium, in particular for the introduction of oxygen in water treatment, comprising an injector (3) for the introduction of gas, an eddy chamber (2) arranged before the injector (3) with at least one constriction in the cross-section thereof and an eddy chamber (4) after the injector (3) with at least one constriction in the cross-section thereof.

The invention pertains to an eddy chamber for generating turbulence in the medium flowing through it, with an inlet and an outlet, and with at least two constrictions in its cross section, where, in cross section parallel to its longitudinal axis, the internal profile of the eddy chamber has the form of wave crests in the area of the constrictions.

The invention also pertains to a device for increasing the concentration of a gaseous medium in a liquid medium, especially for supplying oxygen during the treatment of water, comprising an injector for supplying the gas, an eddy chamber upstream of the injector with at least one constriction in its cross section, and an eddy chamber downstream of the injector with at least one constriction in its cross section, where, in cross section parallel to its longitudinal axis, the internal profile of the downstream eddy chamber has the form of a wave crest in the area of the constriction.

Devices of this type are commonly used in wastewater technology for the purification of water and for the processing of drinking water. Ozone, which is intended to oxidize the pollutants, solid components, suspended particles, etc., present in the water is injected into the water by an injector. A device of this type, however, is also suitable in general for combining a gas with a liquid in order to bring about a desired reaction in the liquid medium.

DE 43 14 507 C1 discloses an injector or mixer for flotation equipment such as fiber suspensions, consisting of two injector plates, which are set up facing each other. These plates have series of elevations extending in the flow direction, which have the effect of constricting the flow cross section. In one embodiment, the elevations become increasingly smaller toward the outlet end, whereas the distance between adjacent elevations becomes correspondingly greater. It has been found that such an arrangement does not lead to optimal mixing results and that in particular the pressure drop between the inlet and the outlet remains relatively large.

DE 34 22 339 A1 discloses a process for the mixing of flowing media, in which a flat, ribbon-like jet is ejected from a slot nozzle and combined with a second flat jet. In the mixing tube, located downstream, the diameter of the flow cross section changes as a result of gradual constrictions and expansions at fixed intervals in the axial direction. As in the case of the injector of the previous publication, the non-optimal mixing and the pressure drop prove to be disadvantageous.

U.S. Pat. No. 6,673,248 B2 discloses a process for the purification of water, according to which the bacteria present therein are eliminated by supplying ozone to an injector. Downstream from the injector is a tubular mixing chamber, the cross section of which is considerably reduced at certain points by baffle plates installed perpendicular to the flow direction. These baffle plates are intended to cause turbulence and thus to increase the mixing between the water flowing through the tube and the ozone. In addition, an arc-shaped obstacle is installed behind the central opening of one of the baffle plates. The view through the pipe along its axis is blocked by the baffle plates and the obstacles.

Even with a device of this type, however, the mixing of the water and the ozone still remains incomplete. One of the reasons for this is that the baffle plates are merely obstacles and lead to an increase in the length of the flow route leading to the outlet of the mixing chamber. The turbulences produced are limited to local areas and are also limited in size. This ozone is not distributed comprehensively and uniformly in the water, but even more importantly, direct contact of the ozone with the components to be oxidized (solid components, suspended particles, etc.) is not satisfactorily achieved.

The analysis of existing devices for increasing the concentration of ozone in liquids has shown that the passage of the gas into the liquid reaches an efficiency of only about 15%. In other words, this means that only 15% of the gas made available actually reaches the substances to be oxidized in the liquid, so that the result after a single oxidation pass is anything but satisfactory, and the treatment with ozone must be carried out over the course of several successive cascades. The size of the plant and/or the number of plant components required is enormous and also leads to high operating costs.

Another disadvantage of the prior art, including that described in U.S. Pat. No. 6,673,248 B2, is that the baffle plates in the flow cross section sharply reduce the flow velocity, and thus an enormous positive pressure is required at the inlet to the device in order to obtain a more-or-less efficient flow at the outlet from the mixing chamber. At an inlet-side pressure of about 5 bars, it can usually be expected that the outlet-side pressure will be in the range of 1-1.5 bars, which represents a huge pressure drop.

There is therefore a need for a device for increasing the concentration of gases in liquids in which the oxidation of the substances in the liquid to be treated proceeds satisfactorily over the course of only a single process step. Higher efficiency means that expensive plant components can be eliminated. At the same time, it should be possible for the device to operate with smaller pressure gradients between the inlet and the outlet, which means that pumps of lower power ratings can be used.

According to the invention, these goals are achieved with an eddy chamber of the type indicated above, in that, in the direction toward the outlet, the angles to the longitudinal axis at the inflection points on the inlet-facing flanks of at least two wave crests become larger.

Through this measure, eddies are induced in the medium without any essential deceleration or impairment to the flow through the eddy chamber. As a result of the inventive design of the constriction, a spatially uniform distribution of the eddies, a rotation of the molecular structure, an expansion of the intermediate spaces in the medium, and a mechanical separation of substances are achieved to a higher degree. As a result of the interplay among these effects, the oxygen actually does arrive directly at the components of the liquid medium to be oxidized. The actually measured efficiency of the oxidation can be as high as 70% and even higher in certain embodiments as a result of the inventive measure.

It is only through the inventive measure that optimal mixing is achieved, because, as a result of the different angles, eddies of different sizes and intensities are generated, so that mixing is ensured both on the macroscopic and on the microscopic scale. That the angles increase in the direction toward the outlet has the positive effect that the pressure drop along the eddy chamber can be kept low. Also advantageous is the synergistic effect which comes about through the increase in the angles in the flow direction, that is, in the direction of the pressure drop, as a result of which eddies continue to be formed efficiently at these points as well.

According to the invention, the goals stated above are achieved with a device of the type indicated above in that, in cross section parallel to its longitudinal axis, the internal profile of the upstream eddy chamber has the form of a wave crest in the area of the constriction, and in that at least two wave crests are provided in at least one eddy chamber, where, in the direction toward the outlet of the eddy chambers, the angles to the longitudinal axis at the inflection points on the inlet-facing flanks of at least two wave crests become larger.

As a result of this measure of an eddy chamber upstream of the injector, the liquid experiences increased turbulence even before direct contact with the ozone, as a result of which the molecular structure in the liquid is significantly altered. The expansion of the cross section following the constriction in the eddy chamber leads to a stretching of the molecular complex and to an expansion of the intermediate spaces. The velocity at which the medium flows decreases in proportion to the increase in cross section. As a result of the change in cross section, very strong inwardly-rotated eddies are formed, which bring about the loosening of the molecules. The particles, some of which are interacting with each other only by way of hydrogen bridges and Van der Waals forces, are thus loosened, and a certain amount of mechanical separation of substances occurs. A medium prepared in this way in the upstream eddy chamber offers an optimal partial pressure for the uptake of the ozone in the following injector.

The negative pressure then caused by a nozzle in the injector and, in association with that, the increase in the flow velocity have the effect of drawing in the gaseous medium and carrying it along. In the following second eddy chamber, the ozone arrives uniformly at the molecules in the water to be oxidized. The inventive profile is responsible for this, because it is able to generate strong eddies of different sizes in a single eddy chamber.

In an embodiment, the internal profile has waves along the entire length of the longitudinal axis, as a result of which the inventive principle is extended to the entire eddy chamber. By means of several wave crests with intermediate troughs, optimal, comprehensive eddies can be generated and maintained along the entire length of the eddy chamber.

In a special embodiment, the angles at the inflection points of at least one wave crest are in the range of 25-55° to the longitudinal axis. As a result of this measure in cooperation with the flow cross section, an optimal relationship can be achieved between the formation of eddies and deceleration of the medium.

In another embodiment, at least two wave crests are provided, where, in the direction toward the outlet, the angles to the longitudinal axis at the outlet-facing inflection points on the flanks of the wave crests become smaller. As a result, the expansion occurring in the direction toward the outlet decreases or slows down, as a result of which eddies of a certain size which have already been formed can be maintained for a longer time after their associated wave crests.

In one embodiment, the cross section in the area of at least one wave crest is less than 40% of the maximum cross section of the eddy chamber. This reduction makes it possible for eddies to be formed in the flowing medium in a comprehensive and spatially homogeneous manner.

The invention is explained in greater detail below on the basis of the drawing:

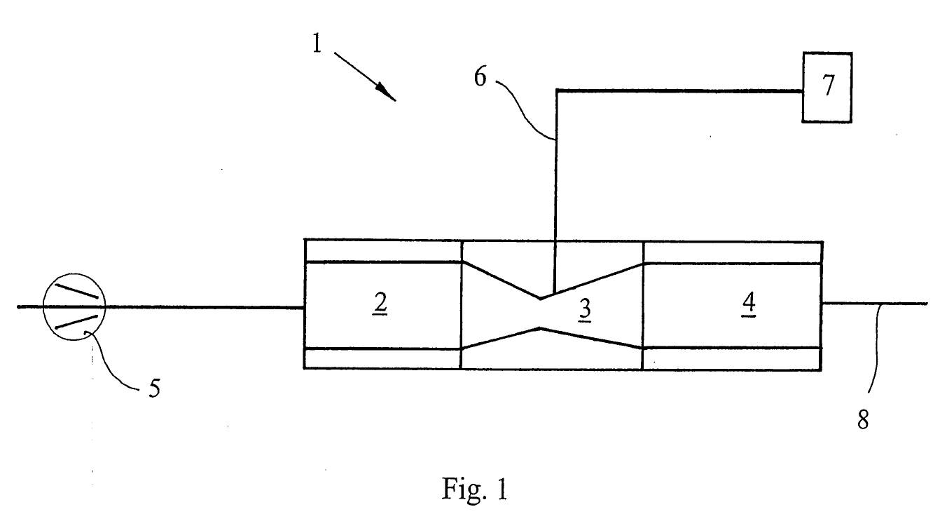

FIG. 1 shows a schematic diagram of the design of an inventive device.

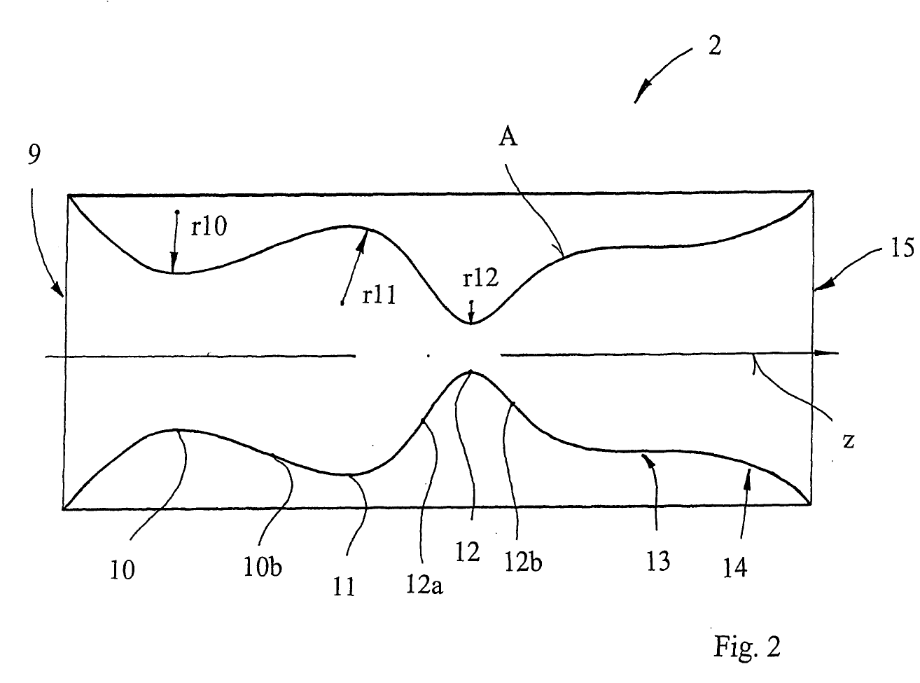

FIG. 2 shows the upstream eddy chamber in cross section parallel to its longitudinal axis.

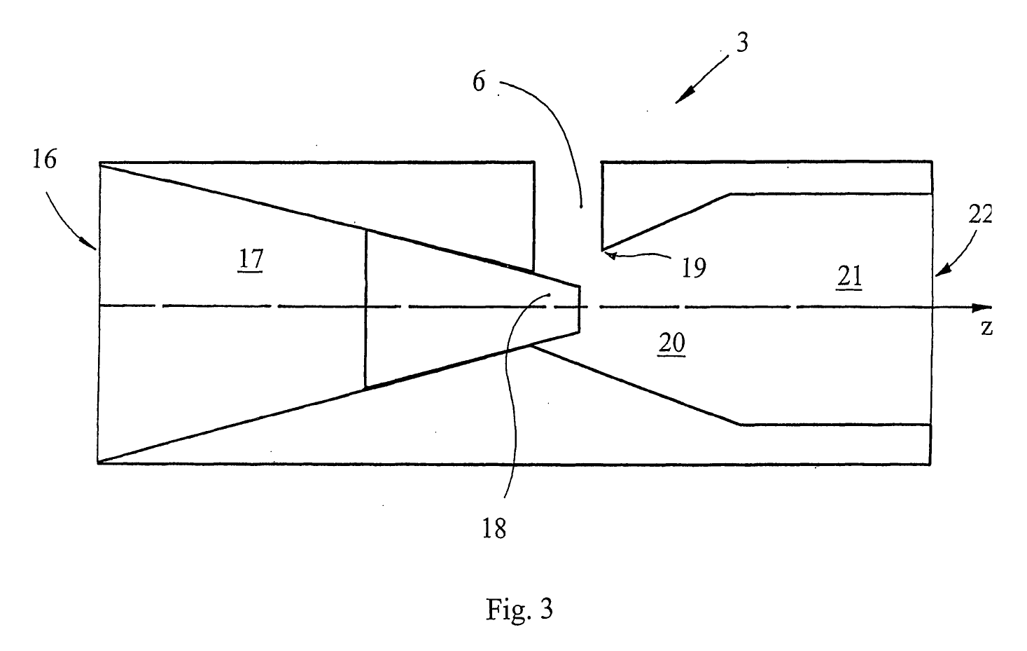

FIG. 3 shows the injector area in cross section parallel to its longitudinal axis; and

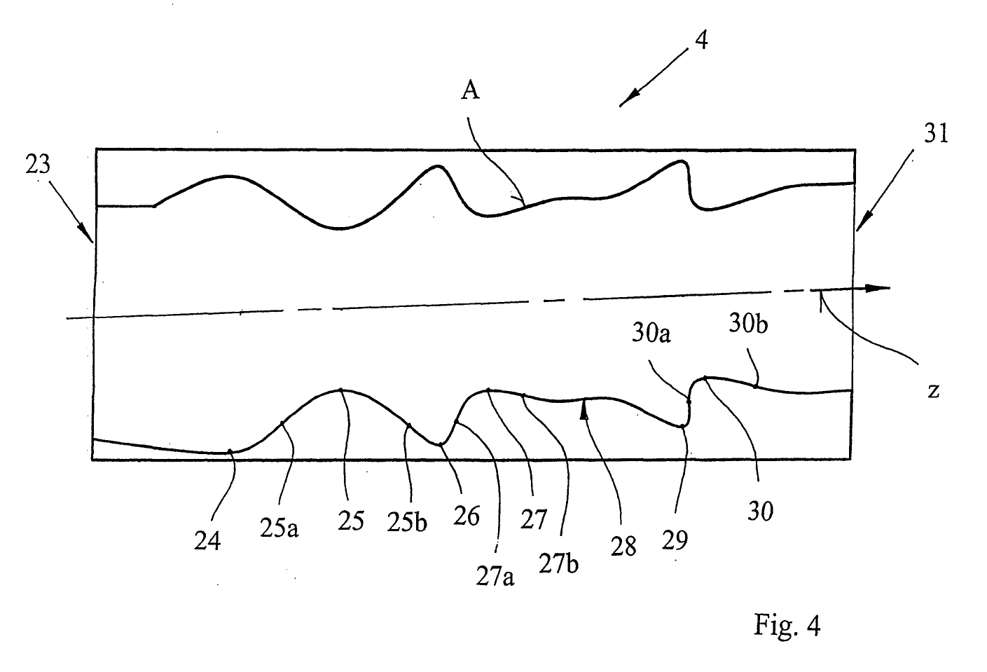

FIG. 4 shows the eddy chamber downstream from the injector in cross section parallel to its longitudinal axis.

FIG. 1 shows a purely schematic diagram of the inventive device 1 for increasing the concentration of a gaseous medium in a liquid, consisting of a pump 5, which pumps the liquid through a feed line to a first eddy chamber 2. A feed line 6 coming from an ozone generator or ozone reservoir 7 leads to the injector 3 downstream from the eddy chamber 2. The negative pressure generated in the injector 3 has the effect of drawing or introducing the gas into the liquid. In the second eddy chamber 4, downstream from the injector 3, the turbulence which is produced guarantees the best-possible mixing of gas and liquid. The discharge line 8 is indicated schematically.

FIG. 2 shows the first eddy chamber 2, which is upstream of the injector 3, in detail. The eddy chamber 2 is tubular in design with an inlet 9 and an outlet 15, preferably with a circular cross section, but the internal profile of the tube differs significantly from that of a cylinder. The longitudinal axis of the eddy chamber is designated “z”, and the arrow shows the direction in which the medium flows.

An essential point is the constriction 12 of the internal cross section, which has the effect of causing wide areas of turbulence in the flowing fluid. As can be seen in FIG. 2, the internal profile defining the cross section along the length of the eddy chamber is wavy. The internal profile in the area of the constriction 12 resembles a hill and is not all that dissimilar to a bell curve. The preferred embodiment of the eddy chamber 2 shown here has a wave-like profile consisting of two wave crests 10, 12. In the case of a symmetric design, the counterpart in the upper half of the cross section is a mirror image of the wave crest on the other side of the longitudinal axis. A trough 11 with a local maximum in the tube cross section is provided between the two wave crests 10, 12, where the cross section in the area of this outward bulge is preferably smaller than the inlet cross section of the eddy chamber, being preferably between 55% and 80% of the inlet cross section. In the exemplary embodiment shown here, it is approximately 65% of the inlet cross section.

The numbers 10b, 12a, and 12b designate the inflection points of the curve. This term will be retained in the following, although in fact what is involved are ring-like lines, which indicate the transition from positive to negative curvature of the surface A lining the interior. The wave crests do not have to be symmetric with respect to their flanks. Thus, the angles at the inflection points 10b, 12a, 12b can be different. The important point—the point which also distinguishes the present invention from the prior art—is that the internal cross section of the eddy chamber first decreases continuously in the area of the wave crest, reaches a minimum, and then expands again continuously.

At the constriction 12, the cross section is preferably less than approximately 25%, and more preferably less than 10% of the inlet cross section. Depending on the design of the other areas of the eddy chamber, it can be advantageous for the cross section to be even less than 5% of the inlet cross section, such as approximately 2.5% in the embodiment shown. In particular, the size of the cross-sectional area also depends on the medium in question, because the formation of the eddies is strongly influenced by the viscosity of the medium. The data given here pertain to the cross-sectional area, not to the radius or diameter.

As can be seen from the diagrams, the change in cross section along the overall length of the eddy chamber does not change abruptly but rather continuously. In the area of the inflection points 12a, 12b, the angle of the surface A to the longitudinal axis z is preferably 35-55°, and more preferably 45°, as shown in the diagram.

The constriction 10 located upstream of the constriction 12 offers a larger flow cross section, preferably a 7-13 times larger cross section, than the constriction 12 does. The flow cross section here is preferably less than approximately 50%, and more preferably less than approximately 30% of the inlet cross section. In the preferred embodiment, it is approximately 25%. The wave crest forming the constriction 10 is also flatter, thus with smaller values for the angles at its inflection points to the longitudinal axis z, so that the distance between the inflection point 10b and the inlet 9 is also greater than the distance between the inflection points 12a and 12b. In the area of the inflection point 10b (there being no inflection point facing the inlet), the angle of the area A to the longitudinal axis z is preferably less than 35°, and more preferably about 20°. The initial angle in the inlet area is preferably between 35° and 55°. In the exemplary embodiment shown, it is about 45°.

In the preferred embodiment, the constriction 12 is located in the area of the center of the eddy chamber 2, whereas the constriction 10 is immediately adjacent to the inlet area and thus, looking in from the inlet 9, is located in the first third of the eddy chamber.

In the immediate vicinity of the constrictions and outward bulges, the internal profile of the eddy chamber can be described approximately by radii of curvature r10, r11, r12, as indicated in FIG. 2. The radius of curvature r10 of the first wave crest 10 and that of the first outward bulge are more than twice as large as the radius of curvature r12 of the wave crest 12.

In the internal surface A of the eddy chamber 2, that is, the surface which is curved in 3 dimensions and which forms the boundary of the internal profile, and which can also be said to line the eddy chamber, has no discontinuities, jumps, kinks, or sharp angles and is therefore in the mathematical sense a continuously differentiable function. Of course, small grooves or bumps can be provided in the profile to generate very small eddies, for example, but this does not change anything with respect to the overall course of the wave profile.

The previously described inventive design of a constriction minimizing the cross section of the eddy chamber leads to the desired, previously mentioned turbulences, without causing any significant deceleration of the flow of medium, as a result of which the pressure difference between the area upstream of the constriction and the area downstream of the constriction is minimized.

Downstream of the constriction 12 there is an expanding area, which merges into an area 14 with an essentially constant cross section of preferably 35-55% of the inlet cross section, here about 45%, until another expansion 14 in the cross section occurs, continuing all the way to the outlet 15.

In the inlet area 9, the velocity of the incoming medium decreases by about 7%, depending on its viscosity, and backs up in the area of the first constriction 10. As a result of the following cross-sectional expansion in the area of the outward bulge 12, the molecules or molecular complexes of the medium are stretched, and the intermediate spaces between the molecules and molecular complexes are expanded. The velocity of the flow decreases essentially in proportion to the increase in cross section. As a result of the change in cross section between the two constriction 10 and 12, powerful, inwardly-rotated eddies are formed. As previously mentioned, these have the effect of loosening the molecular complexes, especially the complexes between solids and dissolved substances. A mechanical separation of substances is also observed to some extent. In the area upstream of and at the outward bulge, there is also an increase in wall friction, and small eddies, which are formed in the area of the constriction 12 or even before it, are present. As a result of the considerable local variation in the particle concentrations in the medium caused by the turbulence, weight displacements in the medium can cause the flow to rotate around the flow axis. This has been demonstrated in experiments. As a result of this twist in the flow and the expansion occurring downstream from the constriction 12, the structure of the medium is changed so significantly that up to 60% of the substances to be oxidized can be mechanically separated in the area of constant cross section and in the following expansion. In the area between the constriction 12 and the outlet 15, there occurs simultaneously a feedback of the eddies in the area near the walls of the eddy chamber, which provides a not insignificant contribution to the mechanical separation.

The medium prepared in this way offers the best possible conditions for an optimal partial pressure in the following injector.

The velocity of the flowing medium from the inlet 9 to the outlet 15 of the eddy chamber depends on the inlet cross section, on the viscosity of the medium, on the flow pressure generated on the inlet side, and on the amount of gas required (and thus also on the negative pressure in the injector). The exact dimensions of the eddy chamber also depend, among other things, on the variables contained in the so-called Reynolds number Re, namely, the density ρ, the flow velocity ν, the viscosity η, and the tube diameter L (Re=ρLν/η). In the case of tube flows, the changeover from laminar to turbulent flow occurs at a Reynolds number of approximately 2300, but in the present case the overall design must always be taken into account in order to arrive a preferred embodiment of the invention.

In the following, a preferred embodiment of the injector will be explained in greater detail on the basis of FIG. 3. The cross section in the inlet area 16 of the injector 3 is essentially the same as the outlet cross section of the first eddy chamber 2. The medium is conveyed at the predetermined pressure by way of a preferably conically tapering channel 17 to the nozzle 18. The size of the nozzle 18 depends on the pressure or velocity of the liquid but also on the vacuum to be produced in the immediate vicinity of the nozzle orifice. The medium to be treated with the gas is always the basis for determining the dimensions of the nozzle cross section. It is preferable for the nozzle to be designed so that it can be moved in the horizontal direction, such as by screwing it in or out. The cross section must be optimized as a function of the viscosity of the medium, because the discharge velocity from the nozzle is the most significant factor determining the intensity of the resulting vacuum. To achieve an optimal partial pressure of the gas/liquid transition phase, a vacuum of approximately −0.4 to −0.6 bar should be produced. The depth to which the nozzle is screwed in relation to point 19, which is defined as an edge for the gas feed 6, is also responsible for the strength of the vacuum. Adaptation to the medium in question is thus possible. Via the gas feed 6, the ozone-air mixture is drawn in and then connected to the medium. Oxidation begins immediately thereafter.

Downstream from the nozzle, another expansion, e.g., of conical shape, of the injector cross section is present in the area 20, followed by an area 21 of constant cross section. The injector outlet is designated 22.

FIG. 4 now shows a preferred embodiment of a second eddy chamber 4, downstream from the injector. Similar to the first eddy chamber 2, the eddy chamber 4 has an internal profile which has at least one local cross-sectional constriction of defined and rounded form.

At the transition from the injector 3 to the eddy chamber 4, an abrupt cross-sectional constriction is provided, where an enormous backed-up eddy forms, which leads to an enormously effective shortening of length.

Like the eddy chamber 2, the internal profile of the eddy chamber also shows waviness in cross section parallel to the tube axis. The preferred embodiment comprises three wave crests 25, 27, 30 and three troughs 24, 26, 29 in the wave-shaped profile. As can be seen in FIG. 4, the longitudinal axis z of the internal profile tilts slightly upward from the horizontal, as a result of which the mixture must travel upward slightly against the force of gravity. The inhomogeneities caused by the sinking of the particles can be more effectively counteracted by this measure, because these particles will then be whirled up immediately again on the wavy profile. As can be seen in FIG. 4, the flanks of the wave crests are nonsymmetrical in all cases; that is, the angles at the two inflection points of a wave crest are different. The angles of the inflection points 25a, 27a, 30a, which are on the side of the wave crests 25, 27, 30 facing the inlet, increase in the flow direction, whereas the angles at the inflection points 25b, 27b, 30b of the flanks facing the outlet decrease. The former can be nearly perpendicular to the tube axis.

As a result of this design of the eddy chamber, especially the design of the different configurations of the wave crests, eddies of different sizes are created. The rounded contours of the internal profile in conjunction with the fact that a flow cross section extends continuously along the entire length of the eddy chamber in the area around the tube axis, which means that it is possible to look straight through the tube, have a highly advantageous effect on the pressure drop between inlet and outlet, because the medium is not stopped or significantly decelerated, as is the case in the prior art, according to which baffle plates creating abrupt cross-sectional constrictions are used. On the contrary, the flow passes by the edges and merely develops a large number of eddies.

The cross section is preferably circular in cross section perpendicular to the longitudinal axis of the tubular eddy chamber, but deviations from the circular also fall under the inventive principle, such as elliptical cross sections or polygonal cross sections with rounded corner areas. Of course, slight deviations from an axially symmetric internal contour of the eddy chamber can also occur. In cross section parallel to the longitudinal axis, two wave crests would in this case not lie directly one above the other but rather be slightly offset from each other. Also conceivable would be an internal profile in which the wave crests wind helically along the eddy chamber at least over a certain section of the chamber. Such deviations from circular symmetry can give the medium an additional effective twist.

It can also be seen in FIG. 4 that the radii of curvature which define the form of the wave crests in the area of their immediate maxima decrease in the direction toward the outlet 15, there thus being a change from flat wave crests to more highly curved wave crests. This gives the internal profile a sharper contour nearer the outlet 15, but this nevertheless retains its rounded form. The same is true for the radii of curvature of the troughs. Whereas large eddies are produced by the flatter contours, smaller eddies can be maintained and/or activated by the more highly curved structures.

In the following, the preferred embodiment will be described quantitatively in greater detail insofar as not already done above.

The inlet area 23 of the eddy chamber 4 has a smaller cross section than the outlet 22 of the injector 3. Following this is an expansion in the cross section to a local maximum 24 in the flow cross section, followed by a local constriction 25. Overall, this eddy chamber has three local constrictions 25, 27, and 30, between which are three expansions or outward bulges 24, 26, and 29 with maximum local cross sections. The corresponding inflection points in the curvature, that is, where the second derivative of the surface curve becomes zero, are designated 25a, 25b, 27a, 27b, and 30a, 30b.

The cross sections in the constrictions 25, 27, and 30 are approximately equal in size and are preferably about 20-40%, and more preferably about 30%, of the maximum cross section in one of the outward bulges. The cross sections in the outward bulges are also all of about the same size. The inlet cross section is preferably about 15-30% of the maximum tube cross section.

Between the constriction 27 in the middle and the following outward bulge 29, there is an area 28 with an essentially constant cross section. From the outlet-side constriction 30 to the outlet 31, the cross section widens out again slightly. The internal profile of the eddy chamber tube 4 is also rounded, and in the mathematical sense the internal surface A represents a continuously differentiatable function.

In place of the area 28 with the essentially constant cross section, it would also be possible to provide, for example, a weak or flat maximum. The inventive feature, that, namely, in the direction toward the outlet 15, 31, the angles to the longitudinal axis z at the inflection points 12a, 25a, 27a, 30a on the inlet (9, 23)-facing flanks of at least two wave crests 10, 12, 25, 27, 30 become larger does not exclude such formations. All the wave crests do not have to fulfill this condition; it is sufficient if at least two do, and these do not necessarily have to be directly adjacent to each other—it would be possible, for example, for a weak maximum to be present between them.

The initial angle in the inlet area is approximately 35° to the longitudinal axis z of the tube. The angle at the inflection point 25a is preferably between 25° and 45°, and more preferably about 36°. The angle at the inflection point 25b is preferably between 30° and 50°, and more preferably about 40°. The angle at the inflection point 27a is preferably between 55° and 70°, and more preferably about 65°. The angle at the inflection point 27b is preferably between 10° and 20°, and more preferably about 15°. The angle at inflection point 28b is preferably between 15° and 35°, and more preferably about 27°. The angle at inflection point 30a is preferably between 80° and 90°, and more preferably about 90°. The angle at inflection point 30b is preferably between 5° and 20°, and more preferably about 11°.

After the short stretch of preliminary oxidation in the injector 3 between the area 20 and the outlet 22, where the medium experiences a relief of pressure (necessary partial pressure areas), the medium being oxidized is sent into the eddy chamber via the appropriately adapted outlet cross section 22. The eddy chamber has the task of decreasing the oxidation distance and thus of decreasing the technical size of the plant. At the transition between the injector 3 and the inlet to the eddy chamber 4, there is a sudden cross-sectional constriction, where an enormous backed-up eddy is created, which, if effectively formed, leads to a significant decrease in the oxidation distance.

In the section between the inlet 23 and the first constriction 25, the gas-treated medium undergoes backward vertical movement, with the result that the oxidation time frame is shortened even more. In the section between the first constriction 25 and the eddy chamber outlet, the medium is accelerated, made even more turbulent, and sent vertically backward again. The shaping achieved over the length of this section leads to a 50% increase in the transfer of gas to the medium as compared to the prior art. As a result of the described configuration, the walls of the eddy chamber bring about a flow-promoting oxidation of the substances in the medium.

The invention is not limited to the embodiment shown. It has been found that even a single constriction in the eddy chamber in question with the inventively designed wave crest is sufficient to significantly increase the efficiency of this type of device with respect to oxygen enrichment. In addition, much smaller inlet-side pump outputs are required. That is, as a result of the continuous constrictions and expansions of the cross section, the eddy chamber offers very little resistance to the flow of the medium, even though large areas of turbulence of all sizes are created. By choosing the number of constrictions and the special designs of the various inflection points, the efficiency of the inventive device can be optimized even more, but these represent preferred embodiments.

1. An eddy chamber for generating turbulence in the medium flowing through it, with an inlet and an outlet, and with at least two constrictions in its cross section, where, in cross section parallel to its longitudinal axis, the internal profile of the eddy chamber has the form of wave crests (10, 12, 25, 27, 30) in the area of the constrictions, wherein the angles to the longitudinal axis (z) at the inflection points (12a, 25a, 27a, 30a) on the inlet (9, 23)-facing flanks of at least two wave crests (10, 12, 25, 27, 30) become larger in the direction toward the outlet (15, 31).

2. An eddy chamber according to claim 1, wherein the angles to the longitudinal axis (z) at the inflection points (10b, 12b, 25b, 27b, 30b) on the outlet (15, 31)-facing flanks of at least two wave crests (10, 12, 25, 27, 30) become smaller in the direction toward the outlet (15, 31).

3. An eddy chamber according to claim 1, wherein the internal profile (A) is essentially circular and symmetric to the longitudinal axis (z).

4. An eddy chamber according to claim 1, wherein the internal profile (A) is wavy along the entire length of the longitudinal axis (z).

5. An eddy chamber according to claim 1, wherein, for at least one wave crest (12, 25), the angles at the inflection points (12a, 12b, 25a, 25b) to the longitudinal axis (z) are between 25° and 55°.

6. An eddy chamber according to claim 1, wherein the cross section in the area of at least one wave crest (10, 12, 25, 27, 30) is less than 40% of the maximum cross section of the eddy chamber.

7. An eddy chamber according to claim 1, wherein two wave crests (10, 12) are provided.

8. An eddy chamber according to claim 7, wherein a wave trough (11) with a local maximum in its cross section is provided between the two wave crests (10, 12), where the cross section at this outward bulge is preferably smaller than the inlet cross section of the eddy chamber (2), preferably between 55% and 80% of the inlet cross section.

9. An eddy chamber according to claim 7, wherein the cross section of the wave crest (12) downstream from the wave crest (10) is less than 25%, preferably less than 10%, and more preferably less than 5% of the inlet cross section.

10. An eddy chamber according to claim 7, wherein the angle at the inflection points (12a, 12b) of the wave crest (12) to the longitudinal axis (z) is between 35° and 55°, and preferably 45°.

11. An eddy chamber according to claim 7, wherein the cross section of the wave crest (10) upstream of the wave crest (12) is less than 50%, and preferably less than 30%, of the inlet cross section.

12. An eddy chamber according to claim 1, wherein three wave crests (25, 27, 30) are provided.

13. An eddy chamber according to claim 12, wherein the cross sections at the wave crests (25, 27, 30) are approximately of the same size and about 20-40%, and preferably about 30%, of the maximum cross section in one of the outward bulges (24, 26, 29) situated between the constrictions, where the cross sections in the outward bulges (24, 26, 29) are approximately of the same size.

14. An eddy chamber according to claim 12, wherein the inlet cross section of the eddy chamber (4) is about 15-30% of the maximum tube cross section.

15. An eddy chamber according to claim 12, wherein the angle at the inflection point (25a) is between 25° and 45°, and preferably about 36°; at the inflection point (25b) between 30° and 50°, and preferably about 40°; at inflection point (27a) between 55° and 70°, and preferably about 65°; at inflection point (27b) between 10° and 20°, and preferably about 15°; at inflection point (28b) between 15° and 35°, and preferably about 27°; at inflection point (30a) between 80° and 90°, and preferably about 90°; and at inflection point (30b) between 5° and 20°, and preferably about 11°, to the longitudinal axis (z).

16. An eddy chamber according to claim 12, wherein an area (28) of essentially constant cross section is provided between the middle wave crest (27) and the downstream outward bulge (29).

17. A device for increasing the concentration of a gaseous medium in a liquid medium, especially for supplying oxygen for water treatment, comprising
an injector (3) for the gas feed;
an eddy chamber (2) upstream of the injector (3), the chamber being provided with at least one constriction in its cross section; and
an eddy chamber (4) downstream of the injector (3), the chamber being provided with at least one constriction in its cross section,
where, in cross section parallel to its longitudinal axis (z), the internal profile (A) of the downstream eddy chamber (4) has the form of a wave crest (25, 27, 30) in the area of the constriction,
wherein in cross section parallel to its longitudinal axis (z), the internal profile (A) of the upstream eddy chamber (2) has the form of a wave crest (10, 12) in the area of the constriction, and in that at least two wave crests (10, 12, 25, 27, 30) are provided in at least one eddy chamber (2, 4), where, in the direction toward the outlet (15, 31) of the eddy chamber (2, 4), the angles to the longitudinal axis (z) at the inflection points (12a, 25a, 27a, 30a) on the inlet (9, 23)-facing flanks of at least two wave crests (10, 12, 25, 37, 30) become larger.

18. A device according to claim 17, wherein, in the direction toward the outlet (15, 31), the angles to the longitudinal axis (z) at the inflection points (10b, 12b, 25b, 27b, 30b) on the outlet (15, 31)-facing flanks of at least two wave crests (10, 12, 25, 37, 30) become smaller.

19. A device according to claim 17, wherein the internal profile (A) of at least one eddy chamber (2, 4) is essentially circular and symmetric to its longitudinal axis (z).

20. A device according to claim 17, wherein the internal profile (A) of at least one eddy chamber (2, 4) is wavy along its entire length of the longitudinal axis (z).

21. A device according to claim 17, wherein the longitudinal axis (z) of the eddy chamber (4) downstream from the injector (3) is tilted slightly upward toward the outlet (31).

22. A device according to claim 17, wherein, at least in the case of one wave crest (12, 25) in at least one eddy chamber (2, 4), the angles at its inflection points (12a, 12b, 25a, 25b) to the longitudinal axis (z) are between 25° and 55°.

23. A device according to claim 17, wherein, in at least one eddy chamber (2, 4), the cross section in the area of at least one wave crest (10, 12, 25, 27, 30) is less than 40% of the maximum cross section of the eddy chamber.

24. A device according to claim 17, wherein two wave crests (10, 12) are provided in the upstream eddy chamber (2).

25. A device according to claim 24, wherein, in the case of the upstream eddy chamber (2), a wave trough (11) with a local maximum in its cross section is provided between the two wave crests (10, 12), where the cross section at this outward bulge is preferably smaller than the inlet cross section of the upstream eddy chamber (2), preferably between 55% and 80% of the inlet cross section.

26. A device according to claim 24, wherein, in the case of the upstream eddy chamber (2), the cross section of the wave crest (12) downstream from the wave crest (10) is less than 25%, preferably less than 10%, and more preferably less than 5% of the inlet cross section.

27. A device according to claim 24, wherein the angle at the inflection points (12a, 12b) of the wave crest (12) to the longitudinal axis (z) is between 35° and 55°, and preferably 45°.

28. A device according to claim 24, wherein the cross section of the wave crest (10) upstream of the wave crest (12) is less than 50%, and preferably less than 30%, of the inlet cross section.

29. A device according to claim 17, wherein three wave crests (25, 27, 30) are provided in the downstream eddy chamber (4).

30. A device according to claim 29, wherein the cross sections at the wave crests (25, 27, 30) of the downstream eddy chamber (4) are approximately of the same size and about 20-40%, and preferably about 30%, of the maximum cross section at one of the outward bulges (24, 26, 29) situated between the constrictions, where the cross sections in the outward bulges (24, 26, 29) are approximately of the same size.

31. A device according to claim 29, wherein the inlet cross section of the downstream eddy chamber (4) is about 15-30% of the maximum tube cross section.

32. A device according to claim 29, wherein, in the downstream eddy chamber (4), the angle at the inflection point (25a) is between 25° and 45°, and preferably about 36°; at the inflection point (25b) between 30° and 50°, and preferably about 40°; at inflection point (27a) between 55° and 70°, and preferably about 65°; at the inflection point (27b) between 10° and 20°, and preferably about 15°; at the inflection point (28b) between 15° and 35°, and preferably about 27°; at the inflection point (30a) between 80° and 90°, and preferably about 90°; and at the inflection point (30b) between 5° and 20°, and preferably about 11°, relative to the longitudinal axis (z).

33. A device according to claim 29, wherein an area (28) of essentially constant cross section is provided between the middle wave crest (27) of the downstream eddy chamber (4) and the downstream outward bulge (29).
